(19) United States
(12) Patent Application Publication
(10) Pub. No.: US 2013/0112035 A1
(43) Pub. Date: May 9, 2013

(54) STEERING WHEEL

(71) Applicant: Kenshi Nagata, Tokyo (JP)

(72) Inventor: Kenshi Nagata, Tokyo (JP)

(21) Appl. No.: 13/664,206

(22) Filed: Oct. 30, 2012

(30) Foreign Application Priority Data
Oct. 31, 2011 (JP) 2011238419

(51) Int. Cl. G05G 1/10

(52) U.S. Cl. CPC G05G 1/10
USPC 74/552

(57) ABSTRACT

There is provided a steering wheel. The steering wheel includes: a rim formed in an annular shape, which is to be gripped by a driver; a hub disposed at the center of the rim in a radial direction of the rim; a spoke connecting the hub to the rim in the radial direction; and a metal core member provided inside the rim, the hub, and the spoke. The metal core member includes: a hub core member provided inside the hub; a spoke core member provided inside the spoke; and a rim core member provided inside the rim. The thickness of the hub core member at the center portion thereof is larger than the thickness of the hub core member at the outer circumferential end portion thereof.

### CROSS-REFERENCE TO RELATED APPLICATION

This application claims priority under 35 USC §119 from Japanese Patent Application No. 2011-238419, filed on Oct. 31, 2011, the entire contents of which are hereby incorporated by reference.

### FIELD OF THE INVENTION

The present invention relates to a steering wheel which is held by a steering shaft of a vehicle body and allows a driver to perform drive manipulations such as steering.

### BACKGROUND OF THE INVENTION

Conventionally, an annular steering wheel is attached to a sheering shaft of a vehicle to allow a driver to perform drive manipulations such as steering. This steering wheel is configured such that an electrical devices manipulation unit including various switches such as a wiper switch and a turn signal switch, an airbag unit, a cover, etc. are attached to a metal core member (see JP-A-2009-214734, for example).

However, in the metal core member of the above conventional steering wheel, a hub core member which engages with the steering wheel is generally shaped like a rectangular parallelepiped, as a result of which the material cost is high and a steering manipulation requires a strong force.

On the other hand, in recent years, steering wheels have been developed which incorporate an airbag device for a driver which serves to confine the driver. However, the incorporation of the airbag tends to increase the weight of the entire steering wheel. Furthermore, since the metal core member needs to strong enough to endure a load that is exerted on the steering wheel when the airbag is developed, the hub core member is made thicker and heavier, which is also a factor in increasing the weight of the entire steering wheel.

### SUMMARY OF THE INVENTION

An object of the present invention is to provide a metal core member which can be reduced in weight while securing necessary strength.

According to one or more illustrative aspects of the present invention, there is provided a steering wheel. The steering wheel includes: a rim formed in an annular shape, which is to be gripped by a driver; a hub disposed at the center of the rim in a radial direction of the rim; a spoke connecting the hub to the rim in the radial direction; and a metal core member provided inside the rim, the hub, and the spoke. The metal core member includes: a hub core member provided inside the hub; a spoke core member provided inside the spoke; and a rim core member provided inside the rim. the thickness of the hub core member at the center portion thereof is larger than the thickness of the hub core member at the outer circumferential end portion thereof

According to one or more illustrative aspects of the present invention, the metal core member further comprises: a cylindrical boss formed in a cylindrical shape and projecting from the center of the hub core member and configured to engage with the steering shaft. A rear surface of the hub core member, which faces the steering shaft, is inclined.

According to one or more illustrative aspects of the present invention, the rear surface of the hub core member is curved.

According to one or more illustrative aspects of the present invention, the hub core member has generally flat uniform thickness portions which are arranged in a left-right direction in a state that the steering wheel is at a reference rotation position where it causes a vehicle provided with the steering wheel to run straight, and uniform thickness portions have penetration holes through which harness lead pipes which project from an electrical devices manipulation unit having a wiper switch are inserted, respectively.

According to one or more illustrative aspects of the present invention, the thickness of the hub core member at an end portion thereof is larger than or equal to 55% of the thickness of the hub core member at the center thereof.

According to one or more illustrative aspects of the present invention, the thickness of the hub core member at the center thereof is 14 mm or more, and the thickness of the hub core member at the end portion thereof is in a range of 8.5 mm to 10 mm.

### BRIEF DESCRIPTION OF THE DRAWINGS

FIG. 1 is a front view showing the overall structure of a steering wheel according to an embodiment of the present invention;

FIG. 2 is a front view of a metal core member;

FIG. 3 is a rear view of the metal core member;

FIG. 4 is a side view of the metal core member;

FIG. 5 is a side view of the metal core member which is placed with its front surface down;

FIG. 6 is a rear perspective view of the metal core member;

FIG. 7 is an enlarged view, corresponding to FIG. 6, of an important part of the metal core member; and

FIG. 8 is a perspective view showing a relationship between the metal core member and a switch unit.

### DETAILED DESCRIPTION OF THE PREFERRED EMBODIMENTS

Exemplary embodiments of the present invention will be hereinafter described with reference to the drawings.

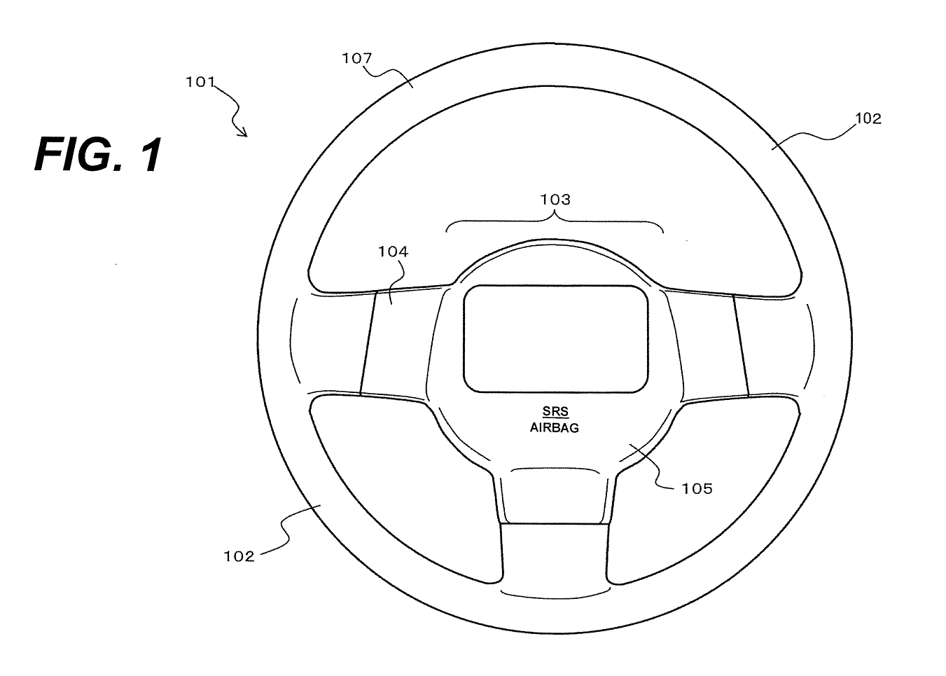

A steering wheel 101 according to an embodiment of the present invention will be hereinafter described with reference to the drawings. FIG. 1 is a front view showing the overall structure of the steering wheel 101 according to the embodiment. As shown in FIG. 1, the steering wheel 101 is equipped with a annular-like rim 102, a hub 103 which is disposed approximately at the center of the rim 102, and plural (in this example, three) spokes 104 which link the hub 103 to the rim 102 in the radial direction. A front cover 105 is attached to a front portion of the hub 103. The rim 102 is formed with a grip 107 which is made of a resin material, for example.

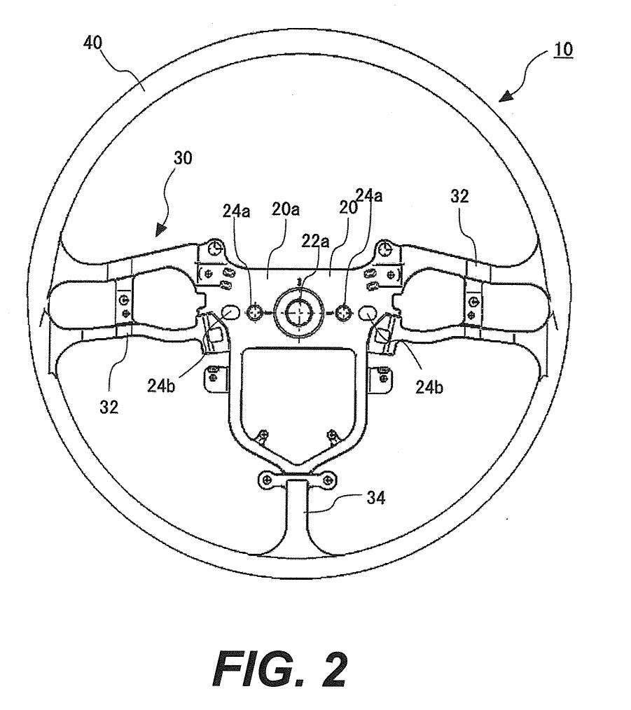

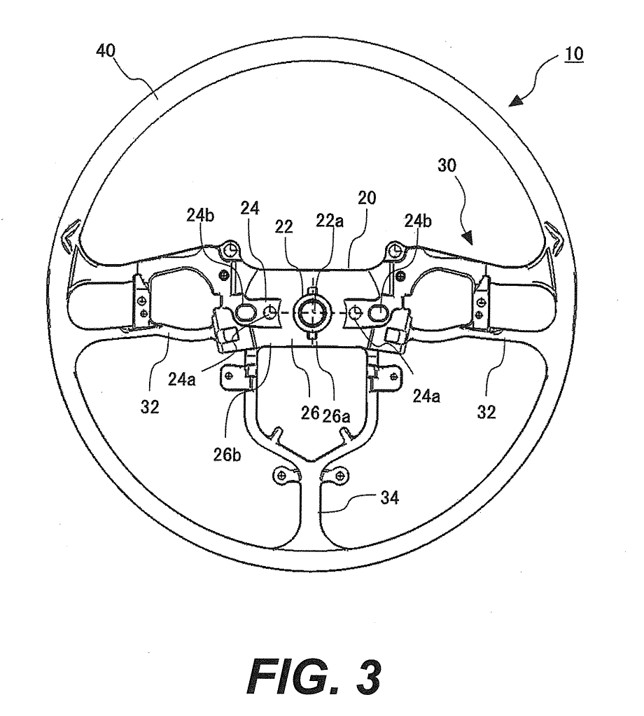

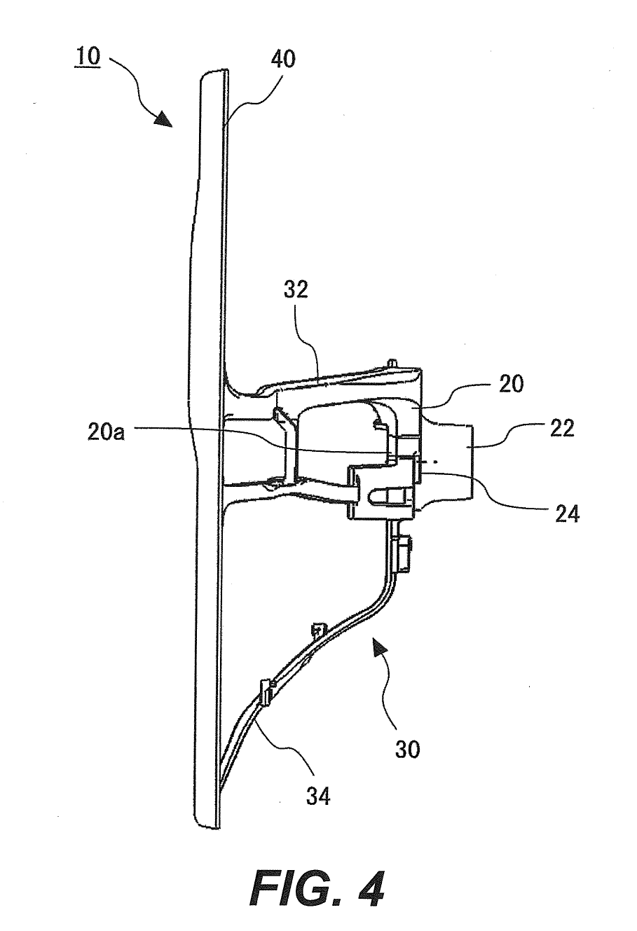

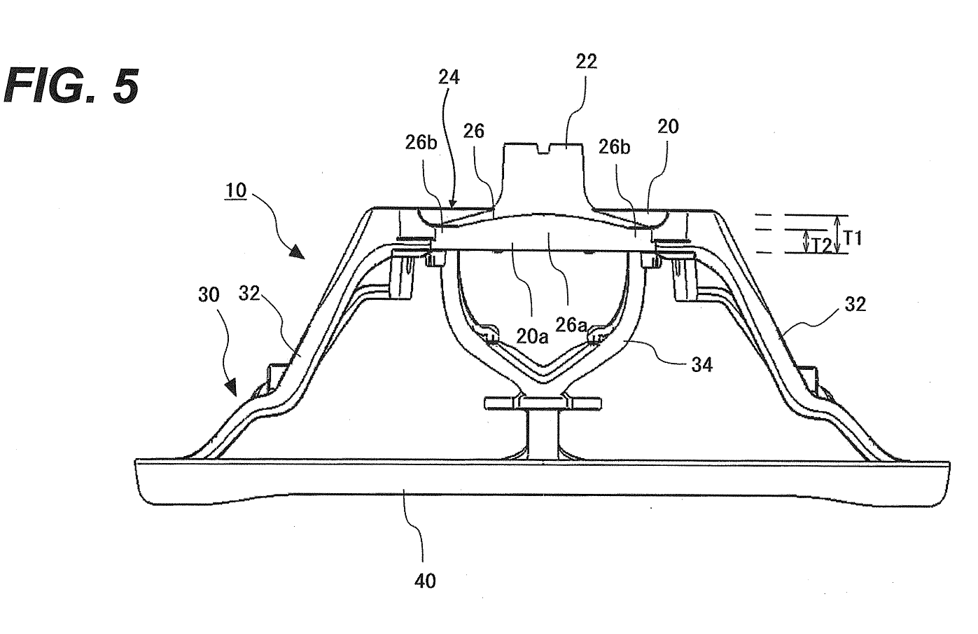

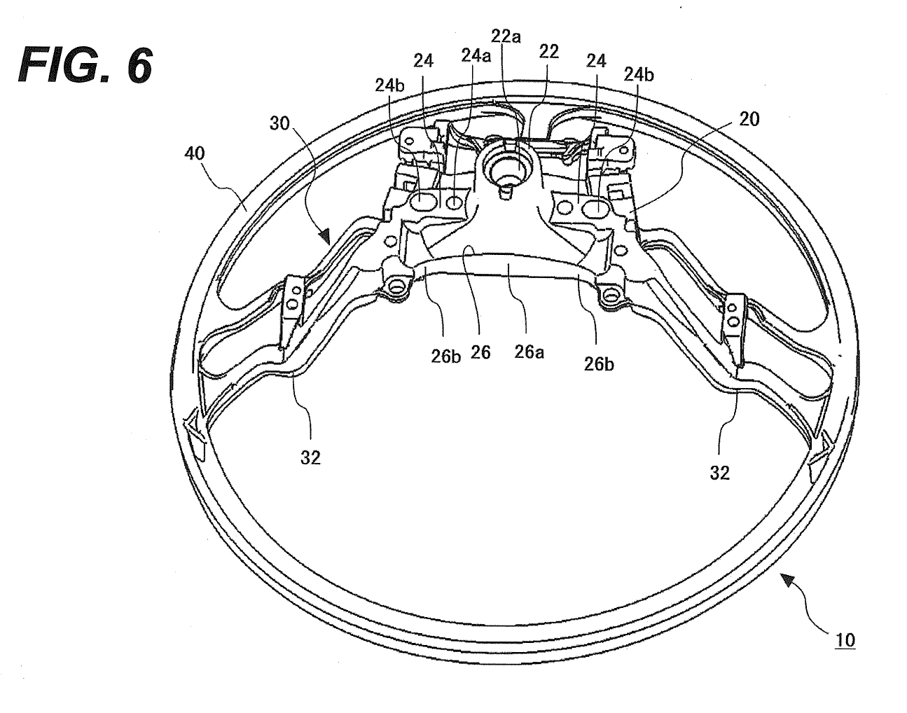

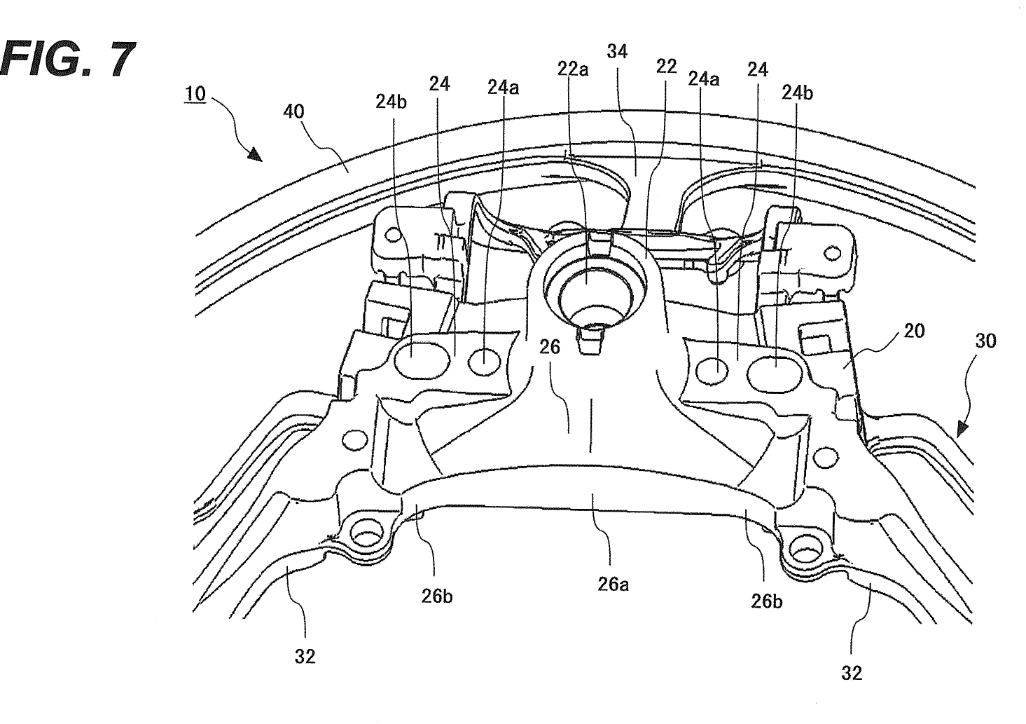

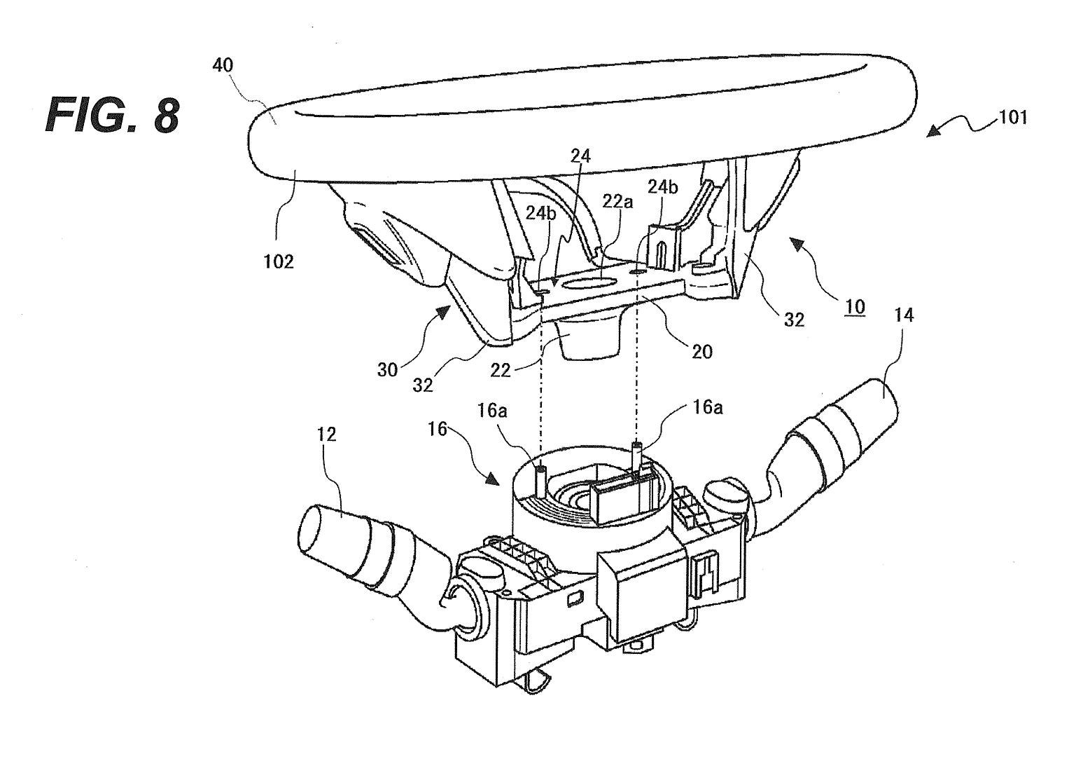

The steering wheel 101 has a metal core member 10 inside. The structure of the metal core member 10, which is an essential element of the embodiment, will be described below with reference to FIGS. 2-8. FIGS. 2-4 are a front view, a rear view, and a side view of the metal core member 10, respectively. FIG. 5 is a side view of the metal core member 10 which is placed with its front surface down. FIG. 6 is a rear perspective view of the metal core member 10. FIG. 7 is an enlarged view, corresponding to FIG. 6, of an important part of the metal core member 10. FIG. 8 is a perspective view showing a relationship between the metal core member 10 and a switch unit.

As shown in FIGS. 2-7, the metal core member 10, which is an integral member made of, for example, a metal or an alloy containing magnesium, is composed of a hub core member 20 which is provided inside the hub 103 and held through engagement with a tip portion of a steering shaft (not shown), a rim core member 40 which is provided inside the rim 102, supported by plural (in this example, three) spoke core members 30, and shaped like a ring so as to surround the hub core member 20, and the spoke core members 30 which are provided inside the respective spokes 104 and link the hub core member 20 to the rim core member 40 in the radial direction.

In the hub core member 20 which is generally rectangular in a front view, a generally cylindrical boss portion 22 is formed at the center (the rotation center as defined by the spoke core members 30) so as to be integral with the other portion and to project rearward. An insertion hole 22a, into which a tip portion of the steering shaft is to be inserted, penetrates through the boss portion 22. Seat portions 24 are formed on both sides of the boss portion 22. The seat portions 24 are flat (i.e., uniform in thickness) and extend in the left-right direction of the vehicle body (in the vehicle width direction) in a state that the steering wheel 101 is at a reference rotation position where it causes the vehicle to run straight (see FIGS. 5-8). A fixing hole 24a and a harness penetration hole 24b are formed through each seat portion 24. Hub surfaces 26 are formed as back surfaces of the hub core member 20 so that the hub core member 20 is thick near the boss portion 22 which is a central portion to engage with the steering shaft and decreases gradually in thickness as the position goes outward in the radial direction to the outside edge. A front surface 20a of the hub core member 20 is flat to enable attachment of an airbag device (not shown) or the like.

As shown in FIG. 5, each hub surface 26 is inclined from a thick portion 26a which is adjacent to the boss portion 22 to a thin portion 26b. It is desirable that each hub surface 26 have a curved surface extending from the thick portion 26a and the thin portion 26b. In this case, where the metal core member 10 is made of magnesium, it is desirable that the thickness T2 of the thin portion 26b be greater than or equal to 55% of the thickness T1 of the thick portion 26a (see FIG. 5). More specifically, it is preferable that the thickness T1 of the maximum thickness portion of the thick portion 26a be greater than or equal to 14 mm and the thickness T2 of the minimum thickness portion of the thin portion 26b be in the range of 8.5 mm to 10 mm. In this case, the thickness T1 of the thick portion 26a is not decreased starting from the boundary with the boss portion 22 and, instead, the thickness T1 of the thick portion 26a is kept approximately equal to the maximum thickness. As a result, each hub surface 26 is generally shaped like a bowl.

The spoke core members 30 are left and right core members 32 which extend in the left-right direction of the vehicle body (in the vehicle width direction) in a state that the steering wheel 101 is at a reference rotation position where it causes the vehicle to run straight and a front-rear core member 34 which extends in the front-rear direction of the vehicle body in the same state.

The rim core member 40 is circular and connected to tip portions of the respective spoke core members 30. The rim core member 40 is circular or rectangular, for example, in cross section.

Incidentally, in tests which are carried out in a state that the airbag mounted in the steering wheel 101 has not been activated (i.e., it is not developed), a heavy load is imposed on the steering wheel 101. To increase the durability of the metal core member 10, the sub surfaces 26 which are peripheral portions of the hub core member 20 need to be thick. Conventionally, each hub surface 26 including its portion adjacent to the boss portion 22 had a constant thickness of about 15 mm. This increased the weight of the hub core member 20. Thus, it was difficult to reduce the weight of the hub core member 20.

In view of the above, the present inventors and other persons analyzed stress distributions with application of a load by a known CAE analysis and have found that weight reduction can be attained while the metal core member 10 is prevented from breaking even when the airbag is developed by setting the thickness of the thick portion 26a which is adjacent to the boss portion 22 (the central portion of the hub core member 20) on which highest stress is exerted greater than or equal to 10 mm and setting the thickness of the thin portion 26b which is distant from the boss portion 22 and on which only low stress is exerted smaller than or equal to 10 mm. We have also found that a stress reducing effect can be obtained by forming a curved surface having an R (a gentle mountain shape in a side view) from the thick portion 26a to the thin portion 26b.

For example, in the above-configured metal core member 10, as shown in FIG. 8, an electrical devices manipulation unit 16 including various switches such as a wiper switch 12 and a turn signal switch 14 is attached to the seat portions 24.

In this case, the electrical devices manipulation unit 16 can be attached to the seat portions 24 stably because the seat portions 24 are flat though the hub surfaces 26 have curved surfaces. The electrical deices manipulation unit 16 is attached to the seat portions 24 by inserting bolts or the like into the fixing holes 24a. At the same time, projected, circular-rod-shaped harness lead pipes 16a are inserted into the harness penetration holes 24b, as a result of which a power cable, a wire harness, etc. provided inside each harness lead pipe 16a can be connected to the airbag device, a horn switch, etc. (not shown) which are mounted on the front surface 20a of the hub core member 20.

As described above, in the embodiment, the hub core member 20 of the metal core member 10 has the thick portions 26a as portions adjacent to the boss portion 22 which is to engage with the steering shaft. With this measure, the portions, adjacent to the boss portion 22, of the hub core member 20 are made as thick as in the conventional structure and necessary strength can thereby be secured. More specifically, when a load is imposed on the steering wheel 101 in a state that the airbag has not been activated (i.e., it is not developed), the thick portions 26a of the hub core member 20 can absorb the load to prevent durability reduction of the hub core member 20. Since the thickness of the hub core member 20 is decreased gradually from the thick portions 26a which are adjacent to the boss portion 22 to the outside edges past the thin portions 26b, respectively, the amount of material used is reduced and the weight can be reduced accordingly.

In the embodiment, in particular, the generally cylindrical boss portion 22 which projects rearward at the center of the hub core member 20 and is to engage with the steering shaft is integral with the other portion of the hub core member 20, and each hub surface (back surface) 26 of the hub core member 20 is inclined from the thick portion 26a to the thin portion 26b to form a curved surface. As stress can be diverted to the back side of the hub core member 20 and the degree of stress concentration on the central portion of the hub core member 20 can be reduced. Thus, the durability reduction of the hub core member 20 can be suppressed even more effectively.

In the embodiment, in particular, the harness insertion holes 24b into which the harness lead pipes 16a are inserted are formed through the seat portions 24 of the hub core member 20. With this measure, whereas weight reduction is attained by forming the thickness portions 26b in the above described manner, a necessary length in the penetration direction of the harness insertion holes 24b through which the harness lead pipes 16a are inserted can be secured by leaving only those portions of the hub core member 20 which are to be penetrated by the harness lead pipes 16a thick and uniform in thickness. As a result, the stability of the penetration structure including the harness lead pipes 16a can be increased and the work of attaching the electrical devices manipulation unit 16 to the steering wheel 101 to form an integral structure can be made easier.

Although the embodiment is directed to the case of using magnesium as a material, a magnesium alloy, aluminum, or an aluminum alloy may be used instead. Where any of these alternative materials is used, the above-mentioned specific numerical values of dimensions may be modified as appropriate taking a strength difference between the materials into consideration.

In the invention, the structures of the spoke core members 30 and the rim core member 40 are not limited to the ones described in the embodiment and their shapes and sizes can be modified as appropriate according to switches and an airbag incorporated.

In addition, features of the above-described embodiment and modifications may be combined as appropriate.

Furthermore, although not described specifically in this specification, various other modifications can be made without departing from the spirit and scope of the invention.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is claimed is:

1. A steering wheel comprising:
a rim formed in an annular shape, which is to be gripped by a driver;
a hub disposed at the center of the rim in a radial direction of the rim;
a spoke connecting the hub to the rim in the radial direction; and
a metal core member provided inside the rim, the hub, and the spoke, the metal core member comprising:
a hub core member provided inside the hub;
a spoke core member provided inside the spoke; and
a rim core member provided inside the rim, and
wherein the thickness of the hub core member at the center portion thereof is larger than the thickness of the hub core member at the outer circumferential end portion thereof.

2. The steering wheel according to claim 1,
wherein the metal core member further comprises:
a cylindrical boss formed in a cylindrical shape and projecting from the center of the hub core member and configured to engage with the steering shaft,
wherein a rear surface of the hub core member, which faces the steering shaft, is inclined.

3. The steering wheel according to claim 2, wherein the rear surface of the hub core member is curved.

4. The steering wheel according to claim 2,
wherein the hub core member has generally flat uniform thickness portions which are arranged in a left-right direction in a state that the steering wheel is at a reference rotation position where it causes a vehicle provided with the steering wheel to run straight, and
wherein uniform thickness portions have penetration holes through which harness lead pipes which project from an electrical devices manipulation unit having a wiper switch are inserted, respectively.

5. The steering wheel according to claim 1, wherein the thickness of the hub core member at an end portion thereof is larger than or equal to 55% of the thickness of the hub core member at the center thereof.

6. The steering wheel according to claim 5, wherein the thickness of the hub core member at the center thereof is 14 mm or more, and the thickness of the hub core member at the end portion thereof is in a range of 8.5 mm to 10 mm.

7. The steering wheel according to claim 1, wherein the thickness of the hub core member is gradually decreased in a direction away from the center portion of the hub core member.
